(19) United States
(12) Patent Application Publication
(10) Pub. No.: US 2006/0136389 A1
(43) Pub. Date: Jun. 22, 2006

(54) System and method for invocation of streaming application

(76) Inventors: Clay H. Cover, Anaheim, CA (US); Gregory Alan Bolcer, Yorba Linda, CA (US); Huy Nguyen, Anaheim, CA (US)

Correspondence Address: Brian R. Coleman;Patent Attorney, Perkins Coie LLP, P. O. Box 2168, Menlo Park, CA, 95026-2168, US

(21) Appl. No.: 11/021,569

(22) Filed: Dec. 22, 2004

(51) Int. Cl. G06F 17/30

(52) U.S. Cl. 707/3

(57) ABSTRACT

A system that initiates streaming of a remotely stored application in response to a data file selection. In one example, in response to a user selection of a data file, a streaming application module determines if a remotely stored published application is available that is capable of opening the data file. If the published application is available, the streaming application module requests that a portion of the published application be streamed to the user system. In addition, the streaming application module may determine if the user is subscribed to the published application. In another example, the streaming application module is invoked if there is not a locally stored application associated with the file type of the selected data file.

### BACKGROUND OF THE INVENTION

1. Field of the Invention

The invention relates to a system and method for streaming applications and, in particular, to a system and method for invoking the streaming of remotely stored applications.

2. Description of the Related Art

In recent years, the availability of electronic information has increased dramatically, especially with the growing popularity of the Internet and email. Much of this electronic information is in the form of non-executable data files. Generally, each data file contains a file extension (e.g., .DOC or .HTM) that identifies the type and format of the data file. Operating systems also use the file extension to find the appropriate executable application, such as a software program, that is capable of opening and/or processing the data file. Oftentimes, computer systems keep a database, such as a registry, of particular file extensions that have been previously linked to and used by a locally stored application.

As can be expected, with the thousands of different types of data files, it has become increasingly difficult and expensive to purchase and maintain applications to open even a small percentage of the available types of data files. Oftentimes, a user does not have locally installed on his or her computer the appropriate application to open a certain type of data file (an “unregistered” file). Furthermore, even if the user has a version of the appropriate application, the version may be outdated and unable to take advantage of all the properties of a data file created with a later version of the application.

In view of the foregoing, some systems attempt to assist the user in finding the appropriate application to open an unregistered data file. For example, when a user of a Windows-based system selects an unregistered data file, such as by “double-clicking” on the data file icon, the user is presented with a dialog box that provides two options: (1) be directed to an Internet service that attempts to find the appropriate application for the unregistered data file; or (2) identify from a list of locally installed applications a specific application capable of opening the unregistered data file.

However, these two options have numerous drawbacks and can be time-consuming and frustrating for the user, especially if the user is not familiar with the type of data file he or she is attempting to open. For example, the Internet service often directs the user to the website of third-party software vendors, leaving the user to figure out how to obtain a copy of the appropriate application. Furthermore, even if the user spends the time and is able to find the appropriate application, oftentimes the application is too expensive for the user, especially if it is only needed for limited use.

With respect to the second option, the user may elect to browse through a list of locally installed applications and manually select an application that the user knows or believes is capable of opening the unregistered data file. However, if the user is not familiar with the unregistered data file, it may be difficult for the user to find an appropriate application that is capable of processing the data file, if such application even exists.

### SUMMARY OF THE INVENTION

In view of the foregoing, an embodiment of the present invention includes a system and a method for invoking the streaming of a remotely installed application to process a data file. For example, in one embodiment, in response to a user selection of a data file, a streaming application module determines if a remotely stored published application is available that is capable of opening the file type of the selected data file. If the published application is available, the streaming application module requests that a portion of the published application be streamed to the user system. Furthermore, the streaming application module may determine if the user is subscribed to the published application.

In another embodiment, the streaming application module is invoked if there is not a locally stored application associated with the data file file type. For example, a user may select a data file for which an associated application is not installed on the user's computer. A streaming application manager then determines if the appropriate application for opening the data file is stored on a remote computer. If the application is available, the streaming application manager requests portions of the application to be “streamed” to the user's computer such that it appears to the user that the application is stored on the user's computer. Once the appropriate portions of the application have been streamed to the user's computer, the streamed portions are used to open the selected data file, even though the entire application is not stored on the user's computer.

In an embodiment of the invention, the streamed portions of the remotely stored application are automatically requested and executed by the user's computer when the user selects an unregistered data file. In another embodiment, the user is presented with the option of using or subscribing to the streamed application. In yet other embodiments, users are presented with links to invoke the streaming of remotely stored applications in order to view and/or open email attachments or files provided by a search engine.

In one embodiment of the invention, a method for responding to a data file selection includes receiving a request to open a data file having a file extension; searching a registry on a first computer to determine if a first association exists between the file extension and an identification of a locally installed application capable of opening the data file; invoking a streaming application module if the first association does not exist; searching a database to determine if a second association exists between the file extension and an identification of a remotely located published application capable of opening the data file, wherein the published application is stored on a remote server; determining if a valid subscription exists for the published application if the second association exists; requesting that at least a portion of the published application be streamed to the first computer if a valid subscription exists; and receiving at the first computer the streamed portion of the published application.

In another embodiment, a method for opening a data file includes receiving first information indicative of a request to open a data file, wherein the data file comprises a file type that is not associated with the identification of a locally installed application capable of opening said file type; determining if there is stored on a remote server a published application capable of opening said file type; and requesting at least a streamed portion of the published application.

In another embodiment, a method for opening a data file with a streaming application includes receiving a first signal indicative of a request to open a data file, wherein the data file is associated with a file type; determining if there is stored on a remote server a published application capable of opening files of said file type; and requesting at least a streamed portion of the published application.

In one embodiment of the invention, a computer system for invoking a streaming application in response to a data file selection comprises a data file having a file extension; a first database capable of storing first associations between a first plurality of file extensions and a plurality of locally installed applications; an operating system capable of receiving a user selection of the data file, the operating system further configured to generate a first signal if the data file file extension is not identified in the first associations; a second database capable of storing second associations between a second plurality of file extensions and a plurality of published applications stored on a remote server; and a streaming application module configured to receive the first signal and, in response to receiving the first signal, determine if a valid subscription exists for an identified published application if a second association exists between the data file's file extension and the identified published application, wherein the streaming application module is further configured to request that at least a portion of the identified published application be streamed from the remote server if a valid subscription exists.

In another embodiment, a system for opening a data file with a streaming application comprises a streaming application module configured to receive first information indicative of a selection of a data file, wherein the streaming application module is further configured to determine if an association exists between the data file file type and a remotely stored published application, and wherein the streaming application module is configured to request that a portion of the published application be streamed from the remote server if the association exists.

In another embodiment, a computer module for opening a data file with a streaming application includes a streaming application module capable of receiving first information indicative of a selection of a data file having a file type, wherein the streaming application module is capable of determining if an association exists between the file type and a published application stored on a remote server, and wherein the streaming application module is capable of requesting at least a streamed portion of the published application if the association exists.

In another embodiment, a system for opening a data file with a streaming application includes means for receiving a first signal indicative of a request to open a data file, wherein the data file is associated with a file type; means for determining if there is stored on a remote server a published application capable of opening data files with said file type; and means for requesting at least a streamed portion of the published application.

In one embodiment of the invention, a machine loadable software program capable of instructing a processor to open a data file with a streaming application includes first software instructions capable of determining if there is stored on a remote server a published application capable of opening a selected file having a file type; and second software instructions capable of requesting at least a streamed portion of the published application.

In another embodiment of the invention, a method of providing a search result to a user includes receiving a search request from a user; reviewing a file type of a search result; determining if an association exists between the search result file type and an identification of a published application; providing the search result to the user; and providing an option to the user to stream at least a portion of the published application if said association exists.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates a block diagram of a streaming application system, according to an embodiment of the invention.

FIG. 2 illustrates a block diagram of an exemplary embodiment of a client system of the streaming application system of FIG. 1.

FIG. 3 illustrates a block diagram of an exemplary embodiment of a server system of the streaming application system of FIG. 1.

FIG. 4 illustrates a data flow diagram of an exemplary embodiment of a streaming application invocation process executable by the streaming application system of FIG. 1.

FIG. 5 illustrates a flowchart of an exemplary embodiment of an application preparation process.

FIG. 6 illustrates a simplified flowchart of an exemplary embodiment of a streaming application invocation process executable by the client system of FIG. 2.

FIG. 7 illustrates a simplified flowchart of another embodiment of a streaming application invocation process executable by the client system of FIG. 2.

FIG. 8 illustrates a simplified flowchart of an exemplary embodiment of a streaming option process usable by a search engine.

FIG. 9 illustrates a simplified flowchart of, an exemplary embodiment of a streaming option process usable in electronic communications.

### DETAILED DESCRIPTION OF THE PREFERRED EMBODIMENTS

The features of the inventive systems and methods will now be described with reference to the drawings summarized above. Throughout the drawings, reference numbers are re-used to indicate correspondence between referenced elements. The drawings, associated descriptions, and specific implementation are provided to illustrate embodiments of the invention and not to limit the scope of the invention.

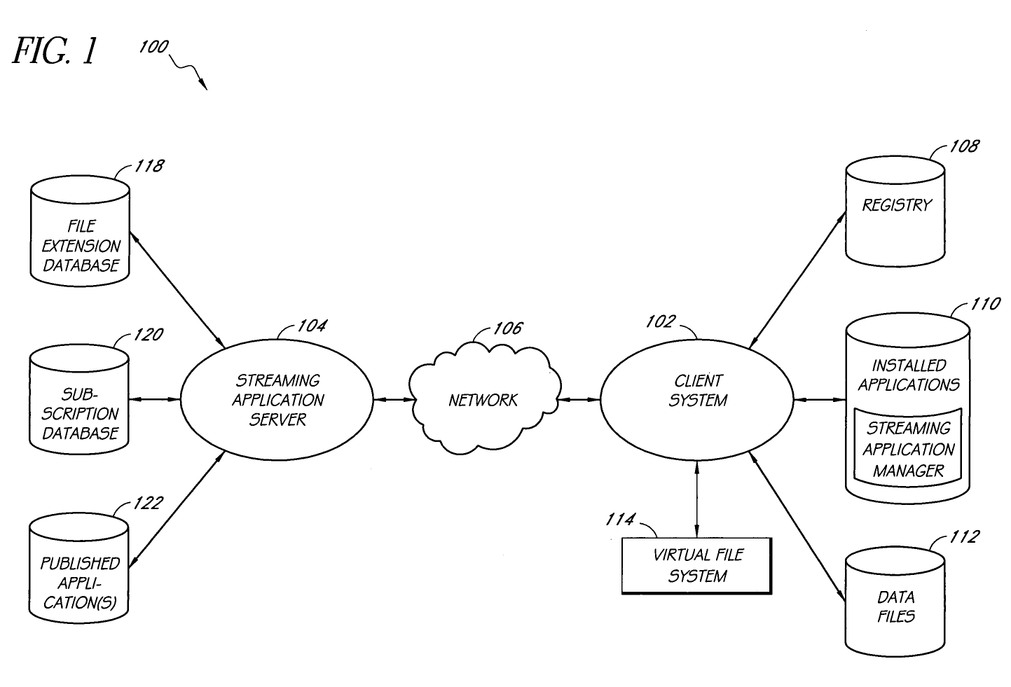

FIG. 1 illustrates a block diagram of a streaming application system 100, according to one embodiment of the invention. As shown, the streaming application system 100 comprises a client system 102 capable of communicating with a streaming application server 104 by sending and/or receiving data through a network 106.

The illustrated network 106 advantageously comprises a computer network such as, for example, a wide area network (WAN). In other embodiments the network 106 may comprise a local area network (LAN), a wireless network, the Internet, a cellular network, wireless data transmission systems, two-way cable systems, customized computer networks, interactive kiosk networks, satellite networks, Intranet networks, broadband networks, baseband networks, combinations of the same and the like.

In one embodiment, the client system 102 advantageously comprises a computing device, such as, for example, a personal computer, that sends, receives, and/or processes data. A wide a variety of devices, systems, and/or apparatuses are usable as a client system. For example, in other embodiments of the invention, the client system 102 may comprise a server system, a network, a mainframe computer, a personal digital assistant (PDA), a portable computing system, a laptop, combinations of the same and the like. In yet other embodiments, the client system 102 may comprise multiple systems.

As illustrated in FIG. 1, the client system 102 communicates with a registry 108, installed applications 110, data files 112, and a virtual file system 114. The installed applications 110 further comprise a streaming application manager 116.

The term “data files” as used herein includes its ordinary broad meaning, which includes any information or data storable on a medium, such as, for example, a memory. In one embodiment, data files advantageously comprise non-executable files that may be created, opened, and/or used by executable applications.

Although the registry 108, the installed applications 110, the data files 112, and the virtual file system 114 are depicted outside the client system 102, any or all of the aforementioned may be stored locally on the client system 102. For example, the data files 112 may be stored in a local memory, such as, for example, a hard drive. In yet other embodiments, the client system 102 may access the registry 108, the installed applications 110, and/or the data files 112 stored at a remote location, such as, for example, on a network server.

FIG. 1 further illustrates the streaming application server 104 communicating with a file extension database 118, a subscription database 120, and published applications 122. In one embodiment, the streaming application server 104 comprises a computing system capable of receiving and processing requests for data and or information. In one embodiment, the streaming application server 104 is capable of streaming information to the client system 102. A wide variety of systems or devices are usable as the streaming application server 104.

The term “stream,” and variations thereof, as used herein includes its ordinary broad meaning, which includes the transferring of portions of a data set, a file, an application, or the like, from a first location to a second location such that the transferred portions may be read or executed at the second location prior to the transfer of the entire file. For example, a streaming application may include portions of an entire application, which portions are capable of being executed or invoked at the second location, such as at the client system 102, even if the entire application has not been sent from the first location, such as from a server system.

Although the file extension database 118, the subscription database 120, and the published applications 122 are depicted outside the streaming application server 104, any or all of the aforementioned may be stored locally on the streaming application server 104. In yet other embodiments, the file extension database 118, the subscription database 120, and/or the published applications 122 may be stored remotely from the streaming application server 104 or may be stored on multiple server systems.

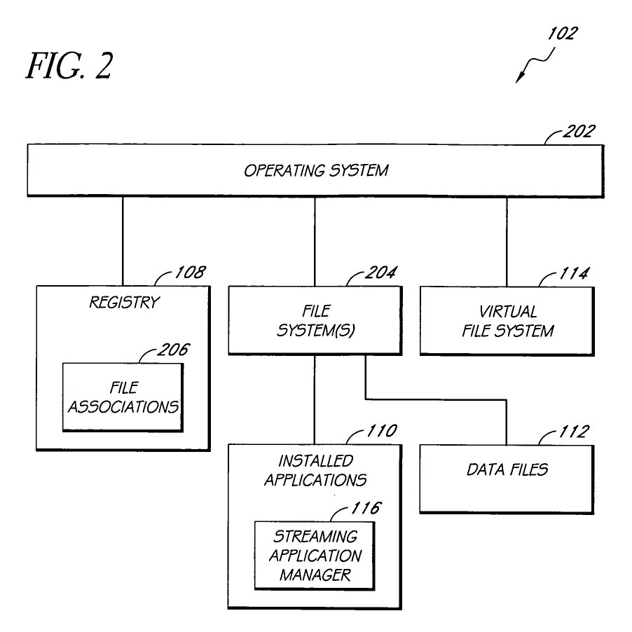

FIG. 2 illustrates further details of an embodiment of a client system 102 usable in a streaming environment, such as with the streaming application system 100 of FIG. 1. As shown, the client system 102 comprises an operating system 202 that controls at least in part the operation of the client system 102 and/or directs the processing of installed programs, such as the installed applications 110. In one embodiment, the operating system 202 is Windows XP. In other embodiments of the invention, the operating system 202 may comprise, for example, UNIX, LINUX, Mac OS X, Disk Operating System (DOS), OS/2, PalmOS, VxWorks, Windows 3.X, Windows 95, Windows 98, Windows Me, Windows NT, Windows CE, or the like.

As shown, the operating system 202 communicates with a registry 108. In an embodiment, the registry 108 comprises a database in which the operating system 202 and/or applications store and/or retrieve configuration information relating to the client system 102.

For example, FIG. 2 shows the registry 108 further comprising file associations 206. In one embodiment, the file associations 206 advantageously link registered file extensions and/or file types to applications usable to open or process files with the linked file extensions. In one embodiment, the file associations 206 list an application identification of at least one of the installed applications 110 usable to open data files 112 with a registered file extension. For example, in Windows-based systems, the file associations 206 may be located in the registry 108 under the registry key “HKEY_CLASSES_ROOT.” Although disclosed with reference to particular embodiments, a wide variety of structures and/or functions for the registry 108 and the file associations 206 may be used.

FIG. 2 further illustrates the operating system 202 communicating with at least one file system 204. In one embodiment, the file system 204 comprises a collection of files and/or directories stored on a given drive, such as, for example, a floppy drive, a hard drive, a disk partition, a logical drive, a RAM drive, or the like. The file system 204 may include, for example, a local file system, a network file system, or the like, or may include multiple file systems accessible by the operating system 202.

As shown, the operating system 202 also communicates with a virtual file system 114. In one embodiment, the virtual file system 114 allows the operating system 202 to call file system functions without having to know the type of file system being used. For example, the virtual file system 114 may simulate the presence of a local drive having stored data files and applications.

FIG. 2 also illustrates the data files 112 and the installed applications 110 being accessible by the file system 204. In an embodiment, the installed applications 110 comprise executable files, such as, for example, software programs loadable in a memory and executable by the operating system 202. The installed applications 110 may also read, create, open, and/or process certain of the data files 112.

As shown, the installed applications 110 comprise a streaming application manager 116. In an embodiment, the streaming application manager 116 comprises an application capable of controlling the streaming of applications from a remote location, such as from a remote server. For example, the streaming application manager 116 may request information regarding a remotely stored application, verify subscription information, request and/or invoke the streaming of a remotely stored application, receive portions of a streamed application, combinations of the same or the like. In addition, the streaming application manager 116 may interact with the virtual file system 114 such that at least one of the remotely stored applications appears to the operating system 202 to be stored locally. A wide variety of functions may be performed by the streaming application manager 116.

Although disclosed with reference to particular embodiments, a wide number of alternatives for the client system 102 may be used. For example, in other embodiments, the virtual file system 114 may also access data files 112 and/or installed applications 110. In yet other embodiments, the file system(s) 204 and/or the virtual file system 114 may access the file associations 206. For example, the file associations 206 may be stored in a file instead of, or in addition to, the registry 108.

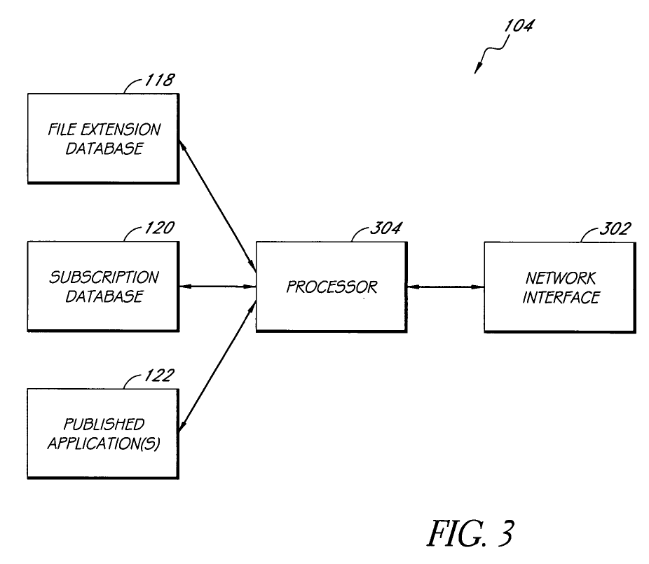

FIG. 3 illustrates further details of an embodiment of a streaming application server 104 usable in a streaming environment, such as with the streaming application system 100 of FIG. 1. As shown, the server 104 includes a network interface 302 for communicating with a data network, such as the network 106 of FIG. 1.

The illustrated server 104 also includes a processor 304 that communicates with the network interface 302 and that further communicates with a file extension database 122, a subscription database 120, and published applications 118. The processor 304 advantageously comprises any computing device capable of controlling at least a portion of the functions of the server 104, such as processing and responding to requests for data. In other embodiments of the invention, the processor 304 may comprise one or more modules configured to execute on one or more processors. The modules may comprise, but are not limited to, any of the following: hardware or software components such as software object-oriented software components, class components and task components, processes, methods, functions, attributes, procedures, subroutines, segments of program code, drivers, firmware, microcode, applications, algorithms, techniques, programs, circuitry, data, databases, data structures, tables, arrays, variables, combinations of the same or the like.

As shown in FIG. 3, the server 104 comprises the published applications 122. In an embodiment, the published applications 122 comprise software programs that have been preprocessed for use in a streaming application environment. Exemplary methods and systems for the preprocessing of applications are further described in U.S. Pat. No. 6,453,334, issued on Sep. 17, 2002, which is hereby incorporated herein by reference in its entirety.

In an embodiment, the subscription database 120 stores information regarding user subscriptions to the published applications 122. For example, the subscription database 120 may store information that identifies which of the published applications 122 is included in a particular subscriber's plan.

In an embodiment, the file extension database 118 stores information relating to particular file extensions or file types. For example, the file extension database 118 may store a list associating particular file extensions with published applications 122 that are capable of opening or processing data files 112 having the associated file extensions. In other embodiments, the file extension database 118 may also store the file extensions for data files 112 not usable with at least one of the published applications 122.

Although disclosed with reference to particular embodiments, a wide number of alternative embodiments for the streaming application server 104 may be used. For example, in other embodiments, the server 104 may comprise multiple servers and/or computing devices. For instance, the published applications 122, the subscription database 120, and/or the file extension database 118 may be stored across multiple servers located in a single location or located remotely from each other. In another embodiment, the subscription database 120 and the file extension database 118 may be combined into a single database.

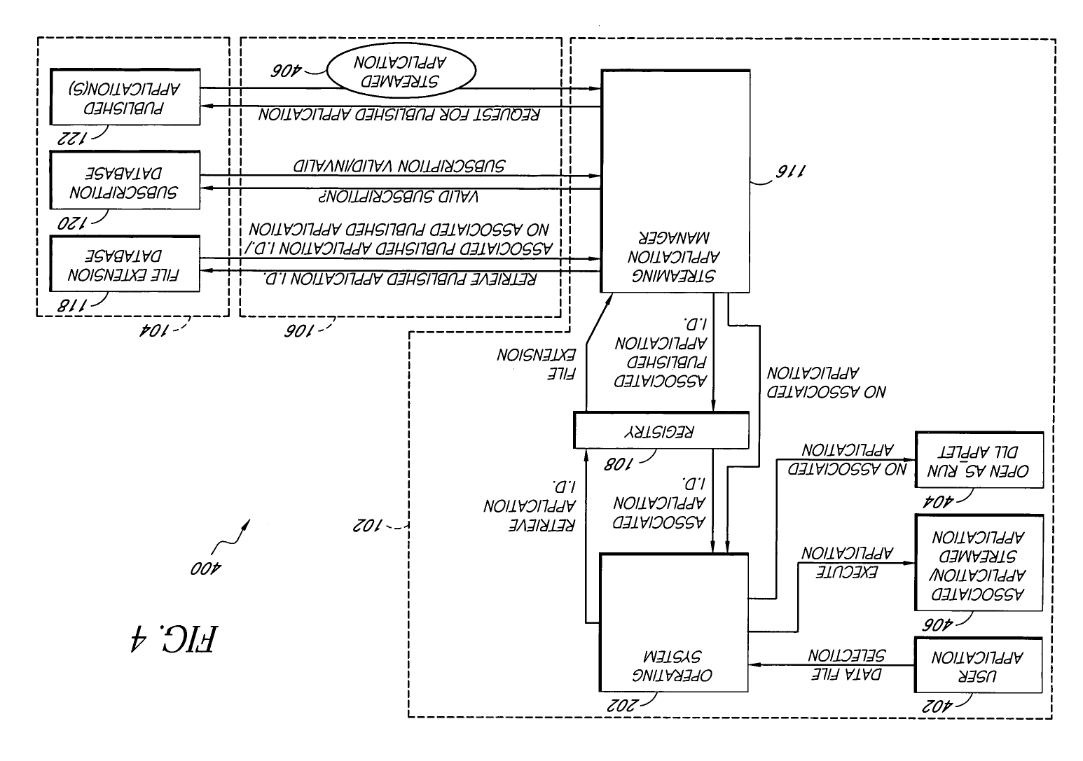

FIG. 4 illustrates a data flow diagram of one embodiment of a streaming application invocation process 400 usable in a streaming environment, such as with the streaming application system 100 of FIG. 1. In general, a client system 102 communicates with a streaming application server 104 through a network 106.

As shown, a user application 402 initially passes a data file selection to an operating system 202. For example, the user may “double-click” on a data file icon, indicating that he or she wants to open the data file. A wide variety of alternatives may be used for selecting a data file. For example, in other embodiments of the invention, a running application may automatically select a data file without direct interaction by the user. Furthermore, the selected data file may be stored locally on the client system 102, may be stored on a network, such as for example, the Internet, or may be attached to an electronic message, such as email, or may be distributed through instant messaging.

After receiving the data file selection, the operating system 202 examines the file extension of the selected data file. Using the file extension, the operating system 202 attempts to retrieve from a registry 108 the identification of an application usable to open or process the selected data file. In particular, the operating system 202 determines if the particular file extension is registered, or associated with an identification of an executable application. For example, in a Windows-based registry, information in the HKEY_CLASSES_ROOT key identifies which executable, locally-stored applications are associated with particular registered file extensions.

In embodiments of the invention having a non-Windows-based operating system 202, the selected data file may include a header block or a header file instead of a file extension. In such an embodiment, the header block or header file identifies, among other things, the file type of the data file.

As shown in FIG. 4, if the operating system 202 finds an associated application identification, the operating system 202 then uses this identification to execute the associated application, which then processes the selected data file.

However, if the operating system 202 does not find an associated application identification, the operating system 202 invokes a streaming application manager 116 and passes to the manager the unknown file extension. In an embodiment of the invention, the operating system 202 invokes the streaming application manager 116 by calling an identification stored in the “Unknown” subkey of the registry 108. In such an embodiment, the operating system 202 may look to the “Unknown” subkey when a file extension is not registered in the registry 108, and may find in the “Unknown” subkey the identification of the streaming application manager 116. For example, the operating system 202 may find the following information in the “Unknown” subkey of the registry 108:
HKEY_CLASSES_ROOT\Unknown\shell\StreamingAppManager
HKEY_CLASSES_ROOT\Unknown\shell\StreamingAppManager\command wherein the “command” subkey includes the application identification used to invoke the streaming application manager 116.

As illustrated in FIG. 4, the streaming application manager 116 receives the unknown file extension and sends a request to a file extension database 118 of the streaming application server 104. In one embodiment, the streaming application manager 116 requests whether or not the file extension database 118 associates a published application with the subject file extension. As is shown, this request is sent through the network 106.

Upon receiving the request, the streaming application server 104 replies to the streaming application manager 116. If the file extension database 118 does not associate a published application with the subject file extension, the streaming application server 104 returns a message to the streaming application manager 116 that no associated published application is identified for the subject file extension. The streaming application manager 116 then notifies the operating system 202 that an associated application does not exist for the subject file extension.

When an associated application is not identified, the operating system 202 then prompts the user for further action. As shown in FIG. 4, the operating system 202 may invoke an OpenAs_RunDLL applet 404, which in a Windows-based system is executed by the Rundll32.exe application. In an embodiment, the OpenAs_RunDLL applet 404 creates a popup window that prompts the user to make one of two selections: (1) use a Web-based service to find the appropriate application to open the selected data file; or (2) manually select an application from a list of available applications to open the selected data file.

A wide variety of alternative methods are usable by the operating system 202 to notify the user when a selected data file does not have an associated application. For example, the operating system 202 may simply notify the user that the data file cannot be opened. In other embodiments, the operating system 202 may ignore a request to open a data file having an unregistered or unknown file extension.

On the other hand, if the file extension database 118 does associate a published application with the subject file extension, FIG. 4 shows that the streaming application server 104 returns to the streaming application manager 116 the identification of the associated published application. The streaming application manager 116 then queries a subscription database 120 whether the user has a valid subscription to use and/or receive the identified published application.

Based on the information stored in the subscription database 120, the streaming application server 104 notifies the streaming application manager 116 of the subscription status of the user. In one embodiment, if the user does not have a valid subscription, or if the user's subscription does not include use of the identified published application, the streaming application manager 116 notifies the operating system 202 that no associated application is available for the selected data file. In another embodiment, the streaming application manager 116 asks the user if he or she would like to subscribe to the identified published application.

If the user has a valid subscription, or if the user subsequently subscribes to the published application, FIG. 4 shows that the streaming application manager 116 requests the identified published application from the published applications 122 stored on the streaming application server 104. The streaming application server 104 then streams at least a portion of the identified published application, shown in FIG. 4 as the streamed application 406, to the streaming application manager 116. In one embodiment, the streamed application 406 includes a general file structure for the identified published application. In other embodiments, the streamed application 406 includes prefetched portions of the identified published application usable by the operating system 202 to invoke the published application on the client system 102 and to open the selected data file.

A wide variety of forms for and methods of streaming the identified published application from the streaming application server 104 to the client system 102 may be used. For example, the streamed application 406 may advantageously include information usable to modify the registry 108 to associate the subject file extension with the identified published application. In other embodiments, the streamed application 406 may include data usable to generate an icon to be associated with data files 112 having the subject file extension.

As shown in FIG. 4, the streaming application manager 116 also updates the registry 108 with the identification of the published application. In one embodiment, the subject file extension is registered in the registry 108 and linked to the identification of the published application. For example, the operating system 202 may later use the identification to directly invoke the published application during subsequent user selections of data files 112 having the subject file extension. In yet other embodiments, the operating system 202 uses the application identification associated with the file extension to invoke the streaming application manager 116, which subsequently invokes the appropriate published application.

As illustrated in FIG. 4, in addition to updating the registry 108, the operating system 202 receives the identification of the published application. In one embodiment, the operating system 202 uses the identification to call the identified published application, such as, for example, by executing the streamed portions of the application in order to process the data file.

In one embodiment, the invocation of the streaming application process disclosed with reference to FIG. 4 is transparent to the user. That is, the identified published application is automatically streamed to the client system 102 if the user has a valid subscription. In such an embodiment, it appears to the user that the remotely stored published application is actually installed on the client system 102, and that the published application automatically opens the user-selected data file.

In yet other embodiments, the user may input additional information to invoke the streaming of the remotely stored published application. For example, the user may be presented with the option of whether or not to stream the appropriate published application if a local application is not available. As another example, the user may be presented with the option of streaming a trial version of the published application so that the user can evaluate whether or not to purchase a full version of the published application.

In another embodiment, the user may be given the option to invoke the streaming of the published application even if a locally stored application is associated with and/or is capable of opening the selected data file. Such an embodiment, for example, gives the user the option to use a more recent version of a software program, which may be stored on the remote server, than what is installed on the client system 102. Moreover, the user may want to use a different program to open a particular data file instead of using one of the locally installed applications 110.

A wide variety of alternative methods and/or structures are usable to invoke a streaming application based on the file extension or file type of a selected data file. For example, in another embodiment of the invention, the file extension database 118 associating file extensions with the published applications 122 is located on the client system 102. For instance, the streaming application manager 116 may look at the locally installed file extension database 118 to determine whether or not a published application exists for a particular file extension. In such an embodiment, the client system 102 may periodically download or update the association information for the file extensions to keep the database information current.

In another embodiment, the streaming application manager 116 may make a single request to the streaming application server 104 for an associated published application. The streaming application server 104 may then automatically determine the subscription information and may send to the streaming application manager 116 the streamed application 406.

In yet another embodiment, the registry 108 is initially modified to associate the file extension with a published application before the published application is streamed to the client system 102. For example, when the streaming application manager 116 is first installed on the client system 102, the registry 108 may be preloaded with the file extensions associated with the published applications 122. When a particular file extension is opened for the first time, the operating system 202 invokes the streaming of the published application based on the application identification stored in the registry 108.

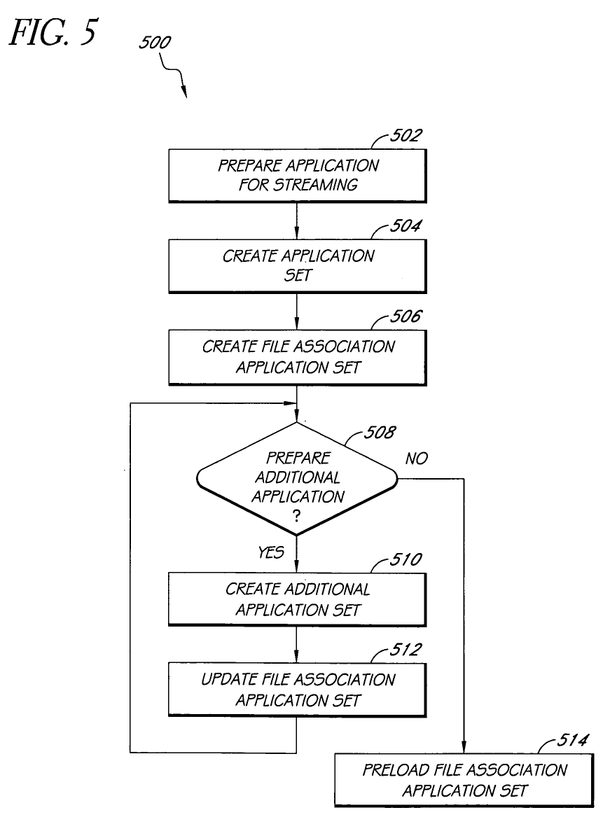

FIG. 5 illustrates a simplified flowchart of an exemplary embodiment of an application preparation process 500 usable to preload the registry 108 of the client system 102. In particular, the process 500 results in the publishing of one or more applications such that the applications may be used in a streaming environment, such as with the streaming application system 100. Furthermore, the process 500 may be executed by one or more computer systems, including, for example, the streaming application server 104.

At Block 502, an application is prepared for execution in a streaming environment. In one embodiment, such preparation includes: taking an initial snapshot of the settings of a computer system, loading the subject application on the computer system, and subsequently taking a second snapshot of the computer system settings. The changes to the computer system resulting from the loading of the subject application are then determined by comparing the second snapshot with the initial snapshot.

At Block 504, the subject application is divided into data blocks used to create an application set. For example, the subject application may be divided into various modules that correspond to the general execution pattern of the subject application. In another embodiment, the subject application may be divided into blocks of a particular size, such as 32 kilobytes. One or more of these data blocks may be individually streamed to the client system 102 during the streaming process.

At Block 506, a file association application set is created that includes the various file associations for the subject application. For example, the file association application set may include a list of all the file extensions usable by the subject application. In one embodiment, this file extension list is compiled by determining which file extensions were modified and/or added to the file association section of a system registry during the loading of the subject application (i.e., changes that occur between the initial snapshot and the second snapshot).

In another embodiment, one or more of the Blocks 502, 504, and 506 are executable by an installation program, such as a Windows installer program. Installation programs generally include instructions used to determine the file extensions associated with an application to be installed on a system. In one embodiment of the invention, these instructions are used to compile the file association application set in Block 506.

Upon creating the file association application set, the process 500 proceeds with Block 508. At Block 508, the process 500 determines if an additional application is to be prepared for streaming. If another application is to be prepared, an application set for the additional application is created at Block 510. This process may be similar to the process described with reference to Block 504.

At Block 512, the file association application set is updated to include the file associations for the additional application such that the file association application set contains the file associations for multiple applications. In another embodiment, instead of updating the initial file association application set at Block 512, a separate file association application set is created for each additional application. Upon completing Block 512, the process 500 returns to Block 508 to determine if another application is available for streaming preparation.

If at Block 508 an additional application is not available for preparation, the process 500 proceeds with Block 514. At Block 514, the file association application set is preloaded onto the client system 102, such as in the registry 108. In one embodiment, the preloaded file associations for particular file extensions point or link to the streaming application manager 116. Thus, when a data file with one of the preloaded file extensions is first selected, the operating system 202 calls the streaming application manager 116, which subsequently requests the streaming of the appropriate published application 122. In other embodiments, the preloaded file associations point or link directly to the appropriate published application 122 instead of the streaming application manager 116. In yet other embodiments, the preloaded file extensions point to the streaming application manager 116 prior to the initial streaming of the published application 122 to the client system 102, after which the file associations are then modified to point or link directly to the appropriate published application 122.

The preloaded file extensions on the client system 102 may also be periodically updated to contain current information with respect to the published applications 122 on the streaming application server 104. Such updating may occur in a variety of ways. In one embodiment, the streaming application manager 116 determines if a list of the preloaded file extensions on the client system 102 is updated with respect to a corresponding list on the streaming application server 104. In yet other embodiments, an application separate from the streaming application manager 116 periodically determines whether the file associations on the client system 102 are current and/or updates them if needed.

In other embodiments of the invention, data relating to the icon for particular file types may be preloaded onto the client system 102. For example, such icon data may be preloaded, as icon associations, in the registry 108. This icon data may also be preloaded as part of the preloading of the file association application set or may be preloaded as a separate module. In one embodiment, the preloaded icon data includes information usable to create and/or point to an associated icon for a data file for which an associated application is not locally installed.

In one embodiment, the icon is the associated icon customarily used with the associated application (i.e., the published application 122 on the streaming application server 104). For example, the icon for Microsoft Word® may include a blue “W” with a white background. This icon may be used even though Microsoft Word® is not locally installed on the client system 102. However, it appears to the user from the icon that Microsoft Word® is locally installed.

In another embodiment, the icons for data files associated with published applications 122 include modified or customized icons. For example, the modified icon may include the icon customarily associated with the particular application along with an additional notation or feature that alerts the user that the subject data file is associated with a published application 122. In yet other embodiments, all icons for data files associated with published applications 122 include the same generic icon. In a further embodiment of the invention, after one of the published applications 122 is initially streamed to the client system 102, the icon for the data file associated with that published application 122 is changed from a modified or generic icon to the customarily-used icon.

In further embodiments, other data may be loaded onto the client system 102 prior to the streaming of published applications 122. For example, the other data may comprise information relating to the file type, information relating to an icon for the particular file extension, combinations of the same or the like.

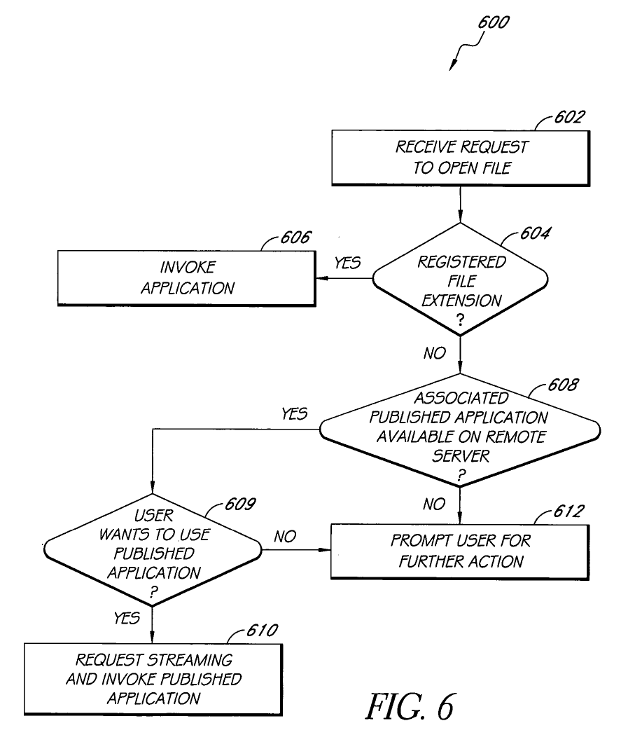

FIG. 6 illustrates a simplified flowchart of an exemplary embodiment of a streaming application invocation process 600 executable by a computing system, such as the client system 102. For exemplary purposes, the invocation process 600 will be described herein with reference to the client system 102 elements depicted in FIG. 2.

As shown, the invocation process 600 begins at Block 602, wherein the operating system 202 receives a request to open a data file. In one embodiment, the data file may be stored in a local memory, such as, for example, on a local hard drive. In other embodiments, the data file may be stored on a network drive; on a removable medium, such as a floppy disk, a compact disk, or a memory stick; as an email attachment; on a web server; or the like. The request may come from a user application, such one initiated by the user “double-clicking” on an icon representing the data file, or an executing application may send the request for the data file.

After receiving the request, the operating system 202 in Block 604 determines if the file extension of the requested data file is registered with the client system 102. For example, the operating system 202 may search the file associations 206 of the registry 108 to determine if the file extension is registered or is associated with a particular application, such as one of the installed applications 110.

If the file extension is registered with the client system 102, the invocation process 600 proceeds with Block 606. At Block 606, the operating system 202 invokes the appropriate associated application, which subsequently opens the data file.

If the file extension is not registered with the client system 102, the invocation process 600 proceeds with Block 608. At Block 608, it is determined whether a published application usable to open the data file is available on a remote server. In one embodiment, the streaming application manager 116 queries a remote server to determine whether a published application is available that is capable of opening data files 112 having the subject file extension.

If an associated published application is available on the remote server, the client system 102 in Block 609 determines if the user would like to use the published application on the remote server. For example, the user may be presented with a pop-up window that gives the user the option of requesting the streaming of the published application. In yet other embodiments of the invention, the invocation process 600 does not include Block 609, and the published application is automatically streamed to and invoked on the client system 102.

If the user indicates that he or she wants to use the published application, the client system 102 in Block 610 requests the associated published application to be streamed to the client system 102. Once the client system 102 receives a portion of the published application, the operating system 202 invokes the streamed application 406, which is subsequently used to open the data file. For example, the client system 102 may receive a file structure and/or streamed portions of the published application usable to invoke the published application as if the entire application was locally stored on the client system 102.

If the user indicates that he or she does not want to use the published application, or if an associated published application is not available on the remote server, the client system 102 in Block 612 prompts the user for further action. For example, the user may be asked to select an appropriate application to open the selected file, or the user may be directed to a website that identifies names of applications that are generally associated with the subject file extension.

In another embodiment of the invention, if the associated published application is not stored on the remote server, the remote server queries a second remote server for the published application. Likewise, the second remote server may query a third remote server, and so forth. Thus, the query for the associated published application may travel through a chain of remote servers before returning an answer or a streamed application 406 in response to the request from the client system 102.

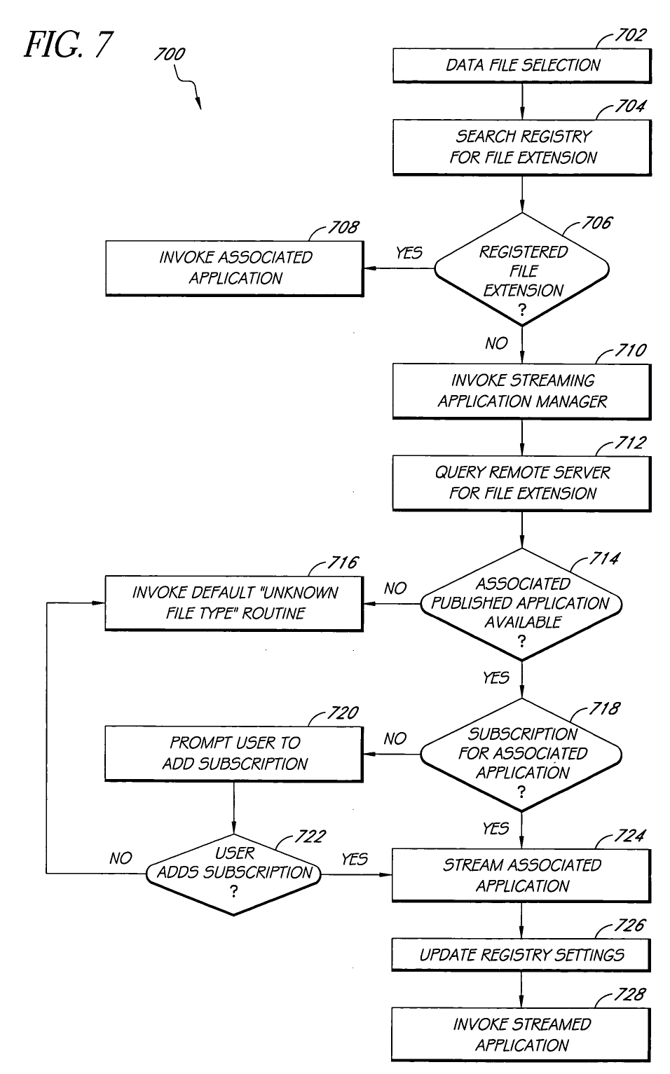

FIG. 7 illustrates a simplified flowchart of an alternative embodiment of a streaming application invocation process 700 executable by a computing system, such as the client system 102. For exemplary purposes, the invocation process 700 will be described herein with reference to the client system 102 and the server system 104 elements depicted in FIGS. 2 and 3.

As shown, the invocation process 700 begins at Block 702, which shows a data file selection. For example, the operating system 202 may receive a request to open a data file, which request may be initiated, for instance, by the user or by another application. In one embodiment, the data file advantageously comprises a file extension indicative of the file type of the data file. Following the data file selection, the invocation process 700 proceeds with Block 704.

At Block 704, the operating system 202 searches the registry 108 for the subject file extension of the selected data file. At Block 706, the operating system 202 determines if the subject file extension is registered with an associated application, such as one of the installed applications 110, that is capable of opening or processing the data file. For example, the operating system 202 may search for an application identification associated with the subject file extension. In one embodiment, the application identification is a hexadecimal numeral that identifies an application that has previously been executed to open at least one data file with the subject file extension.

If the file extension is registered with the client system 102, the invocation process 700 proceeds with Block 708, where the operating system 202 invokes the associated application. In one embodiment, the operating system 202 uses the application identification in the registry 108 to call the appropriate application, which is then used to open or process the selected data file.

If the file extension is not registered with the client system 102, the invocation process 700 proceeds with Block 710. At Block 710, the operating system 202 invokes the streaming application manager 116. In one embodiment, when the operating system 202 is unable to locate a particular file extension in the registry 108, the operating system 202 defaults to the command or instructions stored in the “Unknown” subkey of the registry. In such an embodiment, the application identification of the streaming application manager 116 may be stored in the “Unknown” subkey of the registry 108, which identification is used to invoke the streaming application manager 116 when the operating system 202 comes across an unregistered file extension.

Although the foregoing description is with reference to particular embodiments, a wide variety of methods or processes are usable to invoke the streaming application manager 116. For example, particular file extensions listed in the registry 108 may be associated with the streaming application manager 116 alone or in addition to being associated with other of the installed applications 110. In another embodiment, the streaming application manager 116 is invoked through the “Open With” option available with Windows-based systems. In such an embodiment, the application identification of the streaming application manager 116 may be listed in the “*” subkey of the registry 108 under the “HKEY_CLASSES_ROOT” key.

Proceeding with Block 712, once invoked, the streaming application manager 116 queries a remote server, such as the streaming application server 104, for the subject file extension. For example, streaming application manager 116 may direct its query to the file extension database 118 of the streaming application server 104.

As illustrated by Block 714, the invocation process 700 determines if an associated published application is available on the remote server and that is capable of opening data files 112 having the subject file extension. If an associated published application is not available, the invocation process 700 proceeds with Block 716. At Block 716, the operating system 202 invokes a default “unknown file type” routine, which notifies the user that the operating system 202 does not recognize the subject file extension and/or is not able to access the appropriate application to open or process the selected data file. In one embodiment, the routine prompts the user for further action. For example, the routine may comprise executing the OpenAs_RunDLL applet 404, which is generally used in Windows-based systems.

If an associated published application is available, the invocation process 700 proceeds to Block 718. At Block 718, the streaming application manager 116 determines if the user has a valid subscription for the associated published application. For example, the streaming application manager 116 may query the streaming application server 104 for the subscription information, or the subscription information may be stored on the client system 102. If the user does not have a subscription for the desired published application, the streaming application manager 116 in Block 720 prompts the user to add the published application to his or her subscription.

At Block 722, the invocation process 700 determines if the published application has been added to the user subscription. If the published application has not been added to the subscription, the invocation process 700 proceeds to Block 716, wherein the operating system 202 invokes the “unknown file type” routine.

However, if the user does have a subscription for the associated published application, or if the associated published application has been added to the user subscription, the invocation process 700 proceeds with Block 724. At Block 724, the remote server streams at least a portion of the associated published application to the client system 102. In one embodiment, the streaming application server 104 streams a file structure and/or initial portions of the published application to the client system 102. In a further embodiment, the initial portions of the published application comprise an initialization block usable by the operating system 202 to invoke the streamed published application and open and/or process the selected data file. In yet other embodiments, the streaming application manager 116 requests, or prefetches, specific portions of the associated published application.

In Block 726, the registry settings of database 204 are updated to reflect the addition of the published application. In one embodiment, the subject file extension may be added to the registry 108. In a further embodiment, the updated file extension may be associated with the identification of the appropriate published application or with the identification of the streaming application manager 116. Thus, upon subsequent selections of data files with the subject file extension, the operating system 202 invokes directly either the published application or the streaming application manager 116.

As shown in Block 728 of FIG. 7, the streamed portions of the published application are then invoked to open or process the selected data file 112. In another embodiment of the invention, the invocation process 700 may advantageously execute Block 728 substantially concurrently with or prior to executing Block 726.

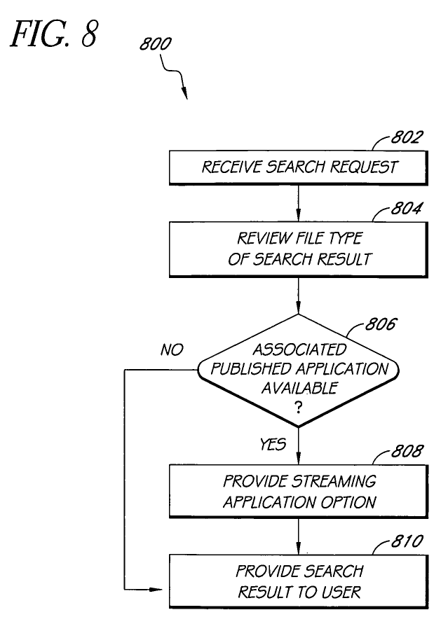

FIG. 8 illustrates a simplified flowchart of an exemplary embodiment of a streaming option process 800 usable by a search engine. The term “search engine” as used herein includes its ordinary broad meaning, which includes any program, in software or hardware, or service that retrieves documents, files, or data related thereto, from a database, a computer network, or the like. For example, an Internet search engine may, in response to a request from a user, retrieve and make available documents and/or information from the Internet that relates to the user request.

As shown, the process 800 begins with Block 802, where the search engine receives a search request. In one embodiment, the search request is sent by a user through a computer network, such as the Internet. For example, the search request may comprise a request for a certain number of documents containing particular keywords and/or attributes, such as a file type.

The search engine advantageously recovers results, such as files and/or documents relating to the search request. In one embodiment, the search engine searches or “crawls” the Internet to find and/or to index files and documents that are publicly available on particular Web servers. The search engine then compiles a list of the search results based on the particular search request.

As shown in Block 804, the search engine then reviews the file type of each search result. For example, the search engine may review the file extension of each data file discovered in the search. In one embodiment, the search engine may identify the search results having file extensions not generally viewable with a Web browser, such as, for example, non-HTML files or the like. In another embodiment, the search engine may identify the data files 112 in the search results for which the user's system does not have a registered file extension and/or the appropriate application to open the subject file type.

After reviewing the file type of the search result, the process 800 continues with Block 806. At Block 806, the search engine determines if a published application is available that is capable of opening and/or processing the search result file type. In one embodiment, the search engine searches a local database that associates available published applications 122 with particular file types. In another embodiment, the search engine accesses a remote database that includes a list of file types and their associated published applications 122.

If a published application is not available for the subject file type of the search result, the search engine provides the search result to the user, as is shown in Block 810. For example, the search result may be included in a list with other related search results. In one embodiment, the search result includes a link, such as a hypertext link, to the file or document identified by the search result.

However, as shown in Block 808, if an associated published application is available, the search engine provides a streaming application option. For example, the search engine may provide to the user a link usable to access the associated published application. In one embodiment, the link is a hypertext link that the user may select to invoke the streaming of the associated published application. In other embodiments, when selecting the link, the user is provided with the option of subscribing to the published application if the user does not have a valid subscription.

As shown in Block 810, the search engine also provides the search result to the user. In one embodiment, the search engine provides the user with a list of search results along with streaming application options, such as links, for each of the non-HTML search results for which there is a published application available.

A wide variety of alternatives to the foregoing process 800 may be used. For example, the published applications 122 may be provided directly by the search engine or may be provided by a third-party service.

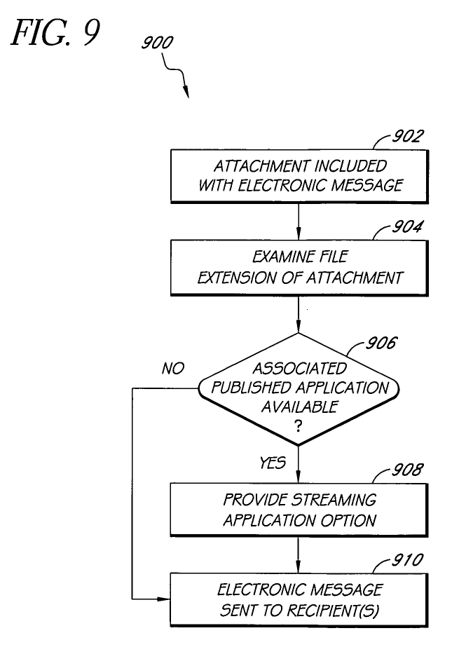

FIG. 9 illustrates a simplified flowchart of an exemplary embodiment of a streaming option process 900 usable in electronic communications. For exemplary purposes, the process 900 will be described with reference to an email system. However, a wide variety of electronic communication systems are usable with the process 900. For example, instant messaging systems, text messaging systems, and the like, may execute the process 900.

The process 900 begins with Block 902 where an attachment file is included with an electronic message. For example, a user may compose an email and attach an accompanying file to the email. When the email is to be sent, an application on the outgoing mail server examines the file extension of the attachment, as shown by Block 904. In one embodiment, the outgoing mail server is a simple mail transfer protocol (SMTP) server.

A wide variety of devices, methods, or systems are usable to examine the file extension of a file used in electronic communication. For example, email programs installed locally on the user computer or user network, and that are used to compose or read the email, may examine the file extension. In other embodiments of the invention, applications on the incoming mail server, such as a post office protocol (POP) server, an exchange server, or an internet message access protocol (IMAP) server, examine the file extension of the attachment.

As shown in FIG. 9, the process 900 proceeds with Block 906, where it is determined if a published application is available that is associated with the subject file extension. For example, a mail server application may search a file extension database 118 or may query a remote database for a published application associated with the file extension.

If an associated published application is not available for the attachment file extension, the electronic message is sent to the recipient, as is shown in Block 910. On the other hand, if an associated published application is available, the process 900 proceeds with Block 908. At Block 908, a streaming application option is provided with the electronic message. For example, an application on the mail server may insert or append to the electronic message a link usable to access the associated published application. In one embodiment, the link is a hypertext link that the user may select to invoke the streaming of the associated published application. In other embodiments, when selecting the link, the user is provided with the option of subscribing to the published application if the user does not already have a subscription. As shown in Block 910, the electronic message is also provided to the recipient along with the streaming application option.

A wide variety of alternatives to the foregoing process 900 may be used. For example, in Block 908, the streaming application option may not be provided if the recipient system already has an installed application capable of opening the attachment.

In addition, the blocks described with respect to FIGS. 6-9 are not limited to any particular sequence, and the blocks relating thereto can be performed in other sequences that are appropriate. For example, described blocks may be performed in an order other than that specifically disclosed or may be executed in parallel, or multiple blocks may be combined in a single block. In addition, not all blocks need to be executed or additional blocks may be included without departing from the scope of the invention.

Furthermore, while certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions

What is claimed is:

1. A method for responding to a data file selection, the method comprising:
receiving a request to open a data file, wherein the data file comprises a file extension;
searching a registry on a first computer to determine if a first association exists between the file extension and an identification of a locally installed application capable of opening the data file;
invoking a streaming application module if the first association does not exist;
searching a database to determine if a second association exists between the file extension and an identification of a remotely located published application capable of opening the data file, wherein the published application is stored on a remote server;
determining if a valid subscription exists for the published application if the second association exists;
requesting that at least a portion of the published application be streamed to the first computer if a valid subscription exists; and
receiving at the first computer the streamed portion of the published application.

2. The method of claim 1, wherein said act of requesting is performed with the streaming application module.

3. The method of claim 1, wherein the request to open the data file is received from a user application.

4. The method of claim 1, wherein the request to open the data file is received by an operating system.

5. The method of claim 1, wherein the database is stored remote to the first computer.

6. The method of claim 1, wherein the database is stored on the first computer.

7. The method of claim 1, additionally comprising prompting the user for further action if neither the first association nor the second association exists.

8. The method of claim 1, additionally comprising updating the registry with association information between the file extension and the published application if the second association exists.

9. The method of claim 1, wherein said act of invoking a streaming application module is transparent to the user.

10. The method of claim 1, additionally comprising executing on the first computer the streamed portion of the published application.

11. A method for opening a data file, the method comprising:
receiving first information indicative of a request to open a data file, wherein the data file comprises a file type that is not associated with the identification of a locally installed application capable of opening said file type;
determining if there is stored on a remote server a published application capable of opening said file type; and
requesting at least a streamed portion of the published application.

12. The method of claim 11, wherein said file type is identified by a file extension.

13. The method of claim 11, wherein said file type is associated with an identification of said published application.

14. The method of claim 11, additionally comprising loading, on a client computer storing said data file, an association between the file type of said data file and an identification of said published application prior to said act of requesting.

15. The method of claim 14, wherein said act of loading is performed prior to said act of receiving.

16. The method of claim 13, further comprising loading, on a client computer storing said data file, icon association information associated with said file type.

17. The method of claim 16, wherein said act of loading is performed prior to said act of receiving.

18. The method of claim 11, wherein said act of determining is performed with a streaming application manager.

19. The method of claim 18, wherein said first information is sent from an operating system to the streaming application manager.

20. The method of claim 18 wherein said act of determining comprises querying a database for an association between the file type of the data file and an identification of the published application.

21. The method of claim 20, wherein the database is located on a different server than the streaming application manager.

22. The method of claim 20, wherein the database is locally stored with the streaming application manager.

23. The method of claim 11, additionally comprising determining if a valid subscription exists for the published application.

24. The method of claim 23, additionally comprising prompting the user for further action if a valid subscription does not exist.

25. The method of claim 11, additionally comprising updating a registry with association information between the file type and the published application capable of opening the file type.

26. The method of claim 11, wherein said acts of determining and requesting are transparent to a user.

27. The method of claim 11, additionally comprising receiving the streamed portion of the published application.

28. The method of claim 11, wherein the streamed portion comprises a file structure of the published application.

29. A method for opening a data file with a streaming application, the method comprising:
receiving a first signal indicative of a request to open a data file, wherein the data file is associated with a file type;
determining if there is stored on a remote server a published application capable of opening files of said file type; and
requesting at least a streamed portion of the published application.

30. The method of claim 29, wherein said file type is identified by a file extension.

31. The method of claim 29, wherein said acts of receiving, determining and requesting are performed by a streaming application module.

32. The method of claim 31, wherein said act of determining includes querying a database for an association between the file type of the data file and an identification of the published application.

33. The method of claim 32, wherein the database is located on a different server than the streaming application module.

34. The method of claim 32, wherein the database is locally stored with the streaming application module.

35. The method of claim 29, additionally comprising prompting the user for further action if the published application is not stored on the remote server.

36. The method of claim 29, additionally comprising determining if a valid subscription exists for the published application.

37. The method of claim 36, wherein said acts of determining if there is stored, requesting at least a streamed portion, and determining if a valid subscription exists, are performed by a streaming application module.

38. The method of claim 36, additionally comprising prompting a user for further action if a valid subscription does not exist.

39. The method of claim 38, wherein said further action comprises establishing a valid subscription for the published application.

40. The method of claim 29, additionally comprising updating a registry with association information between the file type and the published application capable of opening the file type.

41. The method of claim 29, wherein said acts of determining and requesting are transparent to a user.

42. The method of claim 29, additionally comprising receiving the streamed portion of the published application.

43. The method of claim 29, wherein the streamed portion comprises a file structure of the published application.

44. The method of claim 29, wherein the data file is stored locally on a client computer.

45. The method of claim 29, wherein the data file is included as an attachment to an electronic communication.

46. The method of claim 29, wherein the data file is stored on a Web server.

47. A computer system for invoking a streaming application in response to a data file selection, the computer system comprising:
a data file having a file extension;
a first database capable of storing first associations between a first plurality of file extensions and a plurality of locally installed applications;
an operating system capable of receiving a user selection of the data file, the operating system further configured to generate a first signal if the data file file extension is not identified in the first associations;
a second database capable of storing second associations between a second plurality of file extensions and a plurality of published applications stored on a remote server; and
a streaming application module configured to receive the first signal and, in response to receiving the first signal, determine if a valid subscription exists for an identified published application if a second association exists between the data file file extension and the identified published application, wherein the streaming application module is further configured to request that at least a portion of the identified published application be streamed from the remote server if a valid subscription exists.

48. The computer system of claim 47, wherein the first database comprises a registry database.

49. The computer system of claim 47, wherein the second database is stored remote to the first database.

50. The computer system of claim 47, wherein operating system is further configured to prompt the user for further action if the second association does not exist.

51. The computer system of claim 47, wherein the streaming application module is configured to operate transparent to the user.

52. A system for opening a data file with a streaming application, the system comprising:
a streaming application module configured to receive first information indicative of a selection of a data file, wherein the streaming application module is further configured to determine if an association exists between the data file file type and a remotely stored published application,
and wherein the streaming application module is configured to request that a portion of the published application be streamed from the remote server if the association exists.

53. The system of claim 52, wherein the file type of the data file is not associated with a locally installed application.

54. The system of claim 52, wherein the file type is identified by a file extension.

55. The system of claim 52, wherein the streaming application module is configured to receive the first information from an operating system.

56. The system of claim 52, wherein the streaming application module is further configured to determine if a valid subscription exists for the published application.

57. The system of claim 56, wherein the streaming application module is further configured to prompt a user for further action if a valid subscription does not exist.

58. The system of claim 52, wherein the streaming application module is further configured to receive the streamed portion of the published application.

59. A computer module for opening a data file with a streaming application, the computer module comprising:
a streaming application module capable of receiving first information indicative of a selection of a data file having a file type, wherein the streaming application module is capable of determining if an association exists between the file type and a published application stored on a remote server,
and wherein the streaming application module is capable of requesting at least a streamed portion of the published application if the association exists.

60. The computer module of claim 59, wherein said file type is identified by a file extension.

61. The computer module of claim 59, wherein determining if the association exists includes querying a database.

62. The computer module of claim 61, wherein the database is located remotely to the streaming application module.

63. The computer module of claim 61, wherein the database is locally stored with the streaming application module.

64. The computer module of claim 59, wherein the streaming application module is capable of determining if a valid subscription exists for the published application.

65. The computer module of claim 59, wherein the streaming application module is further configured to receive the streamed portion of the published application.

66. The computer module of claim 59, wherein the streamed portion comprises a file structure of the published application.

67. A system for opening a data file with a streaming application, the system comprising:
means for receiving a first signal indicative of a request to open a data file, wherein the data file is associated with a file type;
means for determining if there is stored on a remote server a published application capable of opening data files with said file type; and
means for requesting at least a streamed portion of the published application.

68. A machine loadable software program capable of instructing a processor to open a data file with a streaming application, the software program comprising:
first software instructions capable of determining if there is stored on a remote server a published application capable of opening a selected file having a file type; and
second software instructions capable of requesting at least a streamed portion of the published application.

69. A method of providing a search result to a user, the method comprising:
receiving a search request from a user;
reviewing a file type of a search result;
determining if an association exists between the search result file type and an identification of a published application;
providing the search result to the user; and
providing an option to the user to stream at least a portion of the published application if said association exists.
